(19) United States
(12) Patent Application Publication
(10) Pub. No.: US 2021/0159699 A1
(43) Pub. Date: May 27, 2021

(54) IMPROVED METHOD FOR MANAGING A GROUP OF ELECTRICAL DEVICES

(71) Applicant: UNIVERSIDAD DEL PAÍS VASCO, Bizkaia (ES)

(72) Inventors: Enrique Kremers, Karlsruhe (DE); Emmanuel De Martel, Karlsruhe (DE); Oscar Barambones, Vitoria (ES); Jose Antonio Cortajarena, Tolosa Gipuzkoa (ES); Patxi Alkorta Egiguren, Ondarroa Bizkaia (ES)

(21) Appl. No.: 16/472,520

(22) PCT Filed: Dec. 21, 2017
(86) PCT No.: PCT/EP2017/084253

§ 371 Date: Jun. 21, 2019

(30) Foreign Application Priority Data
Dec. 22, 2016 (FR) 16 63219

(51) Int. Cl. H02J 3/14; G05B 19/042

(52) U.S. Cl. CPC H02J 3/14; G05B 2219/25257; H02J 2203/20; G05B 19/042

(57) ABSTRACT

A method for managing a group of electrical devices having at least one cyclic electrical device includes planning a cyclic operation for a cyclic electrical device, defining, for said cyclic electrical device, at least one cycle phase that is altered relative to a corresponding nominal phase. The planning is based on at least (i) the nature of the current phase among a first nominal phase and a second nominal phase, (ii) quantity adapted to be representative of an imbalance between a request for electrical power made to a supply network and the electrical power made available by the supply network, (iii) and a quantity representative of an estimate of the value of a characteristic quantity of the cyclic electrical device relative to a set value of the current phase; and implementing said planning from a start time.

The invention relates to the field of managing a group of electrical devices, in particular a group comprising at least one electrical device adapted to have a cyclic operation.

In known manner, obtaining a balance between the request for electrical power made to a supply network and the electrical power that made available is a strong constraint, which manifests itself in particular by the need to have production reserves that can be rapidly employed to compensate for a temporary increase in demand.

In order to limit the use of this type of reserve which relate to the electrical power supply of the network, some approaches aim to act directly on the request made to the supply network, for example by applying erasure policies through which devices that consume electrical power are temporarily constrained in their electrical power consumption without affecting the constraints that these devices must satisfy.

Nevertheless, policies of this type which are aimed at regulating demand by interacting directly with consuming electrical devices have drawbacks. Indeed, they rely on approaches requiring dedicated and sometimes complex equipment, both in its operation and in the required manipulations, especially by users. This usually results in tricky operations to perform, typically for the installation of this equipment, which often require the use of a technician.

In addition, the invention aims to improve the situation.

For this purpose, the invention relates to a method for managing a group of electrical devices connected to an electrical power supply network, the group comprising at least one so-called cyclic electrical device initially employing a nominal cyclic operation comprising a plurality of nominal cycles, each nominal cycle comprising a first nominal phase during which the cyclic electrical device draws electrical power from the network in order to regulate a characteristic quantity of said device as a function of a first set value, and a second nominal freewheeling phase during which the device does not use electrical power to regulate said characteristic quantity, said characteristic quantity tending towards a second nominal set value in second nominal phase, the method comprising:
for at least one cyclic electrical device, planning the operation for said cyclic electrical device, defining, for said cyclic electrical device, at least one cycle phase that is altered relative to the corresponding nominal phase, said planning being based on at least the nature of the current phase among the first and second nominal phases, a quantity adapted to be representative of an imbalance between a request for electrical power made to the supply network and the electrical power made available by the supply network and a quantity representative of an estimate of the value of the characteristic quantity of said cyclic electrical device relative to a set value of the current phase, the planning being associated with a start time intended for the implementation of said planning, and
implementing said planning from the start time.

According to one aspect of the invention, the method further comprises a learning step during which operating data of said cyclic electrical device is collected, said quantity representative of an estimate of the value of the characteristic quantity of said cyclic electrical device relative to a set value of the current phase being based at least depending on the operating data collected during the learning step.

According to one aspect of the invention, the intended time is chosen to intervene during a given phase of the nominal cycle and before the intended end of said given phase, said given phase forming an altered cycle phase.

According to one aspect of the invention, said given phase is a first phase, the planning defining an erasure of said cyclic electrical device.

According to one aspect of the invention, the planning module is configured to build and implement the planning according to the value of a connection function denoted L(t), defined by the ratio:

L(t)=ƒ(ƒᵢ(t),ƒ_{grid}(t))

or ƒ_{grid}(t) is a frequency of an electric current supplied by the network R and ƒᵢ(t) is a function of a variable value over time and representative of a threshold value of the frequency of the network according to which the implementation of a planning of the operation of the device is detected as to be implemented.

According to one aspect of the invention, function ƒᵢ(t) depends on the current nominal phase at time t and a state variable representative of the estimated state progress of the corresponding nominal phase and constituting an estimate of the value of the characteristic magnitude relative to the corresponding set value.

According to one aspect of the invention, in the nominal first phase, function ƒᵢ(t) is increasing between a minimum value and a maximum value strictly lower than a nominal value of the frequency of the current supplied by the network R.

According to one aspect of the invention, function ƒᵢ(t) is the minimum value over a range of values of the corresponding state variable from a minimum value of said state variable corresponding to a value of the variable state strictly greater than said minimum value.

According to one aspect of the invention, in the second nominal phase, function ƒᵢ(t) is decreasing between a maximum value and a minimum value strictly greater than a nominal value of the frequency of the current supplied by the network.

The invention further relates to a computer program comprising instructions for implementing the method as defined above when executed by a processor.

The invention furthermore relates to a group of electrical devices connected to a power supply network, the group comprising at least one so-called cyclic electrical device adapted to initially employ a nominal cyclic operation comprising a plurality of nominal cycles, each nominal cycle comprising a first nominal phase during which the device draws electrical power from the network in order to regulate a characteristic quantity of said device as a function of a first set value, and a second nominal freewheeling phase during which the device does not use electrical power to regulate said characteristic quantity, said characteristic quantity tending towards a second nominal set value in second phase, the group of devices comprising at least one management module associated with said cyclic electrical device and comprising:
a detection module configured to determine a quantity adapted to be indicative of an imbalance between a request for electrical power made to the supply network and the electrical power made available by the supply network,
a planning module coupled to said detection module and configured to plan the operation of said cyclic electrical device defining for said cyclic electrical device at least one cycle phase altered relative to the corresponding nominal phase, said planning being based on at least the nature of the current phase among the first and second nominal phases, the quantity adapted to be indicative of an imbalance between a request for electrical power made to the supply network and the electrical power made available by the supply network and a quantity representative of an estimate of the value of the characteristic quantity of said cyclic electrical device relative to a set value of the current phase, the planning being associated with an initial time intended for the implementation of said planning, the planning module being further configured to trigger the implementation of said planning by the cyclic electrical device from the initial time.

According to one aspect of the invention, the management module is external to said cyclic electrical device and is arranged to connect the cyclic electrical device to the supply network for supplying said cyclic electrical device with electrical power.

According to one aspect of the invention, the management module is integrated with said cyclic electrical device.

The invention will be better understood upon reading the detailed description which follows, given only by way of example and with reference to the attached figures, in which:

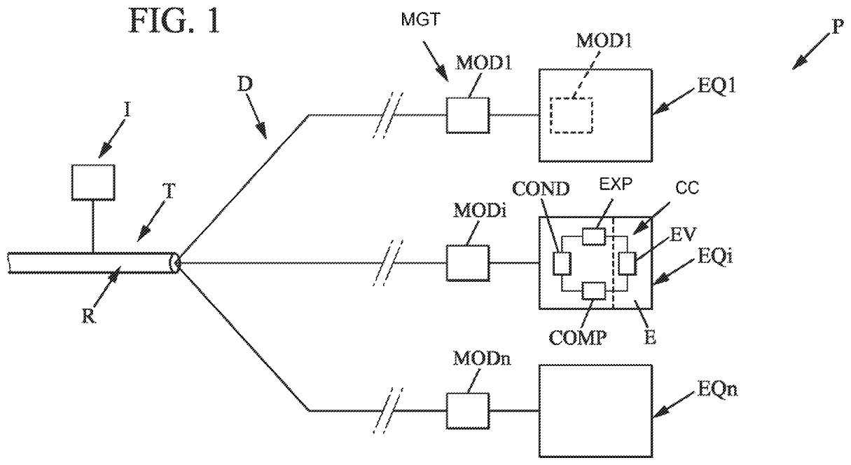

FIG. 1 is an illustration of a group of electrical devices according to the invention;

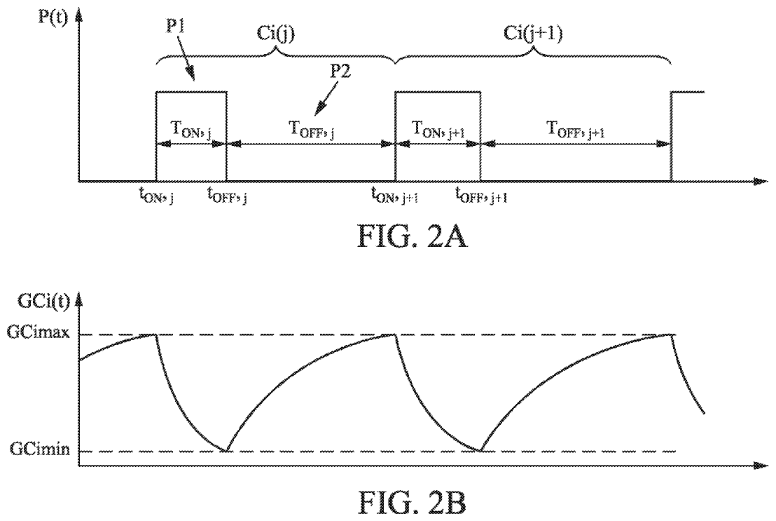

FIGS. 2A and 2B are illustrations of the operation of a cyclic electrical device of the group of FIG. 1;

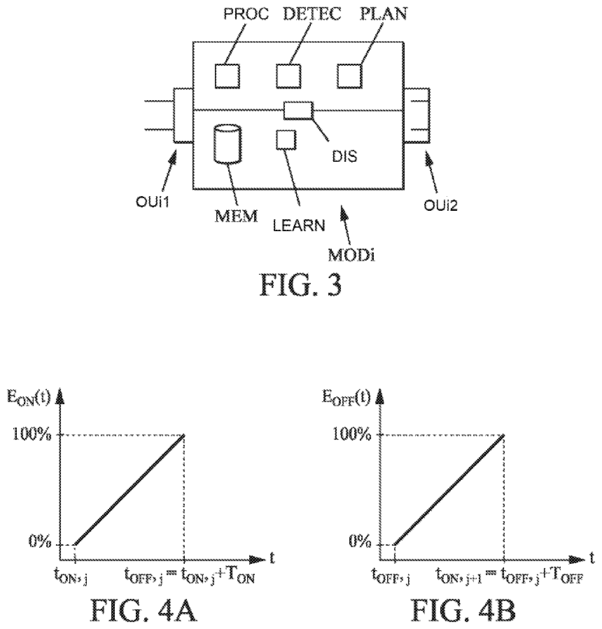

FIG. 3 illustrates a management module according to the invention; and

FIGS. 4A and 4B illustrate state variables of a group management module;

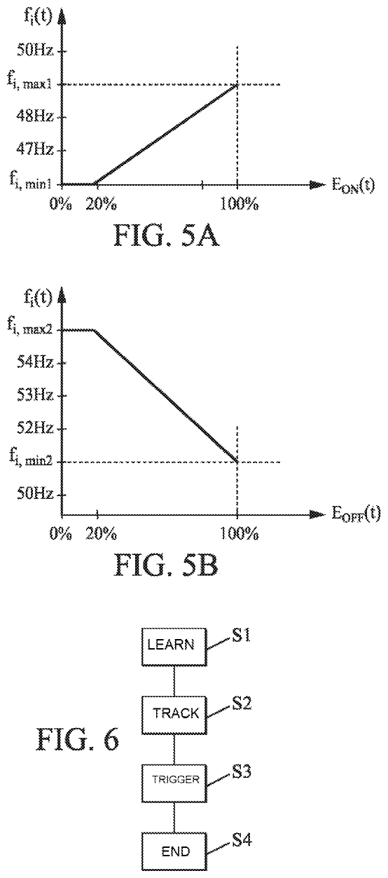

FIGS. 5A and 5B illustrate functions used in context of the operation of the group;

FIG. 6 illustrates a management method according to the invention.

FIG. 1 illustrates a group P according to the invention. The group P comprises a plurality of electrical devices EQi (i being for example less than a non-zero integer n) configured to consume electrical power for the operation thereof.

The group P is connected to at least one electrical power supply network R from which the devices EQi draw electrical power for the operation thereof. Advantageously, the group is connected to a single network R. It is noted that this network can cover a larger or smaller area, such as a neighborhood, a town, an island, a region, a country or even a continent.

The network R is connected to at least one electricity generation installation I configured to generate electrical power and inject this energy into the network for the consumption of the devices connected to it, including the devices of the group P.

The network R is schematically illustrated. In practice, the network R comprises, for example, a transport portion T for covering large distances and a distribution portion D for connecting users to the rest of the network R. The distribution portion D may comprise a high voltage portion called HTA, in particular to connect certain users of the industrial type, and a low voltage portion called BT typically connected to the high voltage portion and via which the residential type of premises are supplied with electrical energy.

The devices EQi are connected to the R network, for example via the low-voltage portion BT.

With reference to FIGS. 2A and 2B, in the context of the invention, at least part of the device of the park P is adapted to have a nominal cyclic operation.

In the following, the illustrated devices EQi are considered in a non-limiting manner as all being cyclic devices, the group P can be seen as optionally comprising non-cyclic electrical devices that are not shown.

Each nominal cycle denoted Ci(j) (where j indicates the cycle), that is to say, each cycle of the nominal operation, comprises a nominal first phase PI during which the corresponding device EQi consumes electrical power in order to regulate a characteristic quantity GCi which characterizes it and via the regulation of which it reaches the desired result.

Each cycle also comprises a second nominal free-wheel phase P2 during which the device EQi does not consume electrical power in order to regulate the characteristic quantity GCi. Note, however, that it can consume electrical power for the purposes of its operation, especially for a lighting function, a function for detecting certain events, etc.

We also note that the terms “first” and “second” are purely illustrative, a cycle which can be considered as comprising a first freewheeling phase, and a second phase for the active regulation of the characteristic quantity.

Phases P1 and P2 are advantageously consecutive within a nominal cycle, each nominal cycle then being made up of these two phases. Furthermore, the cycles are advantageously consecutive in the context of the nominal operation.

In FIGS. 2A and 2B, the first phase P1 of the cycle Ci(j) starts at a time t_{ON,j} and ends at a time t_{OFF,j}. The second phase starts at the time t_{OFF,j} and ends at a time t_{ONJ+1}, which advantageously corresponds to the start time of the following cycle Ci(j+1). Note for the simplicity of writing, the quantities t_{OFF,j}, t_{ON,j}, T_{ON}, T_{OFF}, etc., are not all indicated by i, that is to say, by the indication of the considered device EQi, but in practice, these quantities differ a priori from one device EQi to another, such that they are to be understood as being indicated by i.

Note that two consecutive nominal cycles are not necessarily identical, especially in terms of phase duration and/or electrical power consumed by the device. In particular, an action of a user on the device may result in a change in the value of the characteristic quantity detected by the device which adjusts its operation accordingly. For example, one or more cycle phases are then adjusted, for example in duration, for example in practice because the characteristic quantity reaching a set value occurs at a time offset in time compared to a configuration in which this action would not have occurred.

In practice, over extended periods, nominal cycles tend to have identical characteristics, especially at least in terms of the durations of their phases.

We note T_{ON} and T_{OFF} the respective characteristic durations of the first and second phases, that is, representative of the durations thereof over time. These durations are determined from the durations of past nominal cycle phases. These quantities are, for example, determined from a predetermined number of past cycles, for example to the order of 10 cycles. For example, this number is greater than 5 cycles, and less than 100 cycles. Furthermore, advantageously, these are recent cycles, that is consecutive cycles preceding the current time. Nevertheless, alternatively, these cycles are distant in the time of the current time.

For example, T_{ON} and T_{OFF} are based on averages of the durations T_{ON,j} and T_{OFF,j} and T0EFJ of first and second phases of the chosen Ci(j) cycles. This average is any average, such as arithmetic, quadratic, geometric, or other.

The characteristic quantity GCi varies during each cycle between a maximum value GCimax(j) and a minimum value GCimin(j). These two values respectively form a set value of the characteristic quantity GCi for a given phase of a cycle.

For example, the value GCimin(j) forms a minimum value, which when reached by the characteristic quantity (the verification of a condition relating to a quantity representative of a difference between this value and the characteristic quantity in general, such as for example the fact that the difference between the characteristic quantity and this value is zero) marks the end of the first phase of a cycle and the beginning of the second phase.

For example, the value GCimax(j) forms a maximum value which when reached by the characteristic quantity (the verification of a condition relating to a quantity representative of a difference between this value and the characteristic quantity in general, such as for example the fact that the difference between this value and the characteristic quantity is zero) marks the end of the cycle.

In FIG. 2B, the maximum values GCimax(j) of the cycles have been illustrated as being equal to the same value GCimax. The GCimin(j) values have also been represented as equal to the same GCimin value.

Note that the GCimax(j) and GCimin(j) values are a priori variable from one cycle to another. For example, they are determined, typically by the device EQi, based on information entered by a user, and/or by a module of the device EQi itself, for example on the basis of events that it is configured to detect, notably via a variation of the characteristic quantity GCi.

In the context of the invention, the cyclic devices are advantageously cooling devices. In other words, they are configured to take heat at a volume in order to lower the temperature.

Advantageously, at least one portion of the cyclic devices are refrigerators and/or freezers. Herein “and/or” means that the considered device is either a refrigerator, a freezer, a device that forms both a refrigerator and a freezer.

In other words, a given cyclic device is advantageously a refrigerator. Alternatively, it is a freezer. Alternatively again, it is both a freezer and a refrigerator.

Alternatively or in parallel, at least some of the cyclic devices are air conditioners. Note that these air conditioners are advantageously adapted to heat and cool according to their current mode of operation.

The corresponding devices advantageously include at least one cooling circuit CC (shown in the device EQi in FIG. 1).

This circuit CC is adapted to cool a volume E. This volume corresponds for example to an internal enclosure of the device in which food is intended to be arranged, especially in the case of a refrigerator and/or freezer. This enclosure is, for example, accessible by a door. Alternatively, this volume is at least partly external to the device and is the interior volume of an installation, such as all or part of a dwelling, a room containing computer devices, etc.

The circuit CC comprises an evaporator EV in thermal contact with the volume E and adapted to collect calories. The circuit further comprises a condenser COND that is thermally connected to the evaporator EV and adapted for the rejection of calories taken outside the volume E. Moreover, the circuit CC comprises a compressor COMP and an expansion valve EXP connecting the condenser COND and the evaporator EV between them and adapted to compress, respectively to relieve a refrigerant flowing in the circuit CC and via which the calorie transfers are operated, and so as to increase, respectively to lower the temperature of the fluid before it enters the condenser, respectively in the evaporator.

In the case of devices EQi configured to generate cold, the characteristic quantity GCi is advantageously a temperature, such as for example a temperature of the evaporator EV or any temperature defined inside the volume E. This temperature is, for example, a temperature of a wall of the evaporator EV.

In addition to devices EQi, the group P includes a MGT management device adapted for the management of the group of devices EQi, in particular for the construction and implementation of operation planning of the device EQi so as to act on the request for electrical power demand made to the network R by the devices EQi.

Advantageously, the management device MGT comprises a plurality of management modules MODi respectively associated with one of the devices EQi.

Several configurations are possible for the management modules MODi.

In a first configuration, the management modules MODi form connection modules external to the corresponding device, and via which the devices EQi are connected to the network. Each device EQi associated with a module MODi of this configuration is connected to the associated module MODi for its electrical power supply (for example via a power cord), the module MODi is itself connected to the network R (for example via a wall outlet such as those available in rooms).

In this configuration, the management module MODi associated with a device EQi is, for example, located in the same room as the device EQi or in a neighboring room.

In a second configuration, the management modules MODi are respectively integrated into the device EQi.

These two configurations are, for example, combined in certain embodiments, some modules MODi being external to the device EQi, others being internal.

With reference to FIG. 3, each module MODi comprises a memory MEM and a processing module PROC. Furthermore, each MODi module includes a detection module DETEC, a planning module PLAN and a learning module LEARN. Moreover, each module MODi according to the first configuration comprises a first outlet OUI1, a second outlet OUE and a disconnection module DIS.

The outlets OUI1 and OUI2 are provided for the electrical connection of the module MODi to the rest of the network R and for the connection of the device EQi associated with the module MODi. Together, these outlets allow the electrical connection of the device EQi to the network R via the module MODi.

These outlets have for example a known configuration, and have for example a female configuration for one (for example the outlet OUE) and male configuration for the other (for example the outlet OUI1).

They are electrically connected to each other for the transit of electrical power between them, for example by one or more conductors.

The disconnection module DIS is arranged at the level of these conductors and is adapted to perform the selective opening and closing to selectively connect and disconnect the two electrical outlets OUI1, OUI2 from each other to authorize, respectively prohibit the transit of electrical power between the network and the device EQi.

The disconnection module DIS comprises for example one or more relays.

In a second configuration, the module MODi is for example devoid of an outlet OUI1, OUE and a disconnection module DIS. It is for example configured to interact with other components of the device, such as a control device for controlling one or more devices adapted to regulate the characteristic quantity, such as those of the cooling circuit CC. For this purpose, the module MODi is configured to communicate with this control device, for example directly, or via a dedicated communication interface, for example of the Zigbee type, USB, or a proprietary interface, and in order to trigger an adjustment of the operation of the device, as described in more detail below. The logic of module MODi, in particular of the module PLAN, is for example arranged in a series approach with the control logic of the operation of the device implemented by this control device.

The memory MEM contains programs, the execution of which by the processing module PROC allows the operation of the module MODi. The memory is for example in the form of one or more volatile or non-volatile data storage elements powered by a battery or not.

The processing module PROC is configured to manage the other components of the module for their proper functioning.

The processing module PROC comprises for example one or more processing units such as a processor or a microcontroller.

The detection module DETEC, the planning module PLAN and the learning module LEARN have been represented in FIG. 3 as dedicated modules separate from the memory MEM and the module PROC.

In practice, they can take any form, notably hardware and/or software. For example, they may comprise dedicated components, and/or a processing module such as for example a microcontroller. Alternatively, they have a single software component stored in the memory MEM and intended to be executed by the processing module PROC for the implementation of the corresponding functionalities. Note also that they can include a hardware component, and a software component.

Optionally, the detection module DETEC is configured to detect the receipt by the module of a command, for example generated by a remote device, in order to modify the operation of the device EQi. This command is for example transmitted by any known means of communication, such as wireless or wired communication means. Advantageously, this command is transmitted by PLC technology, by power line communication.

Furthermore, the detection module DETEC is configured to detect a quantity adapted to be representative of an imbalance between the request made to the network and the supply of electricity from the network.

Advantageously, this quantity is or is based on the frequency of the network R.

In known manner, a network such as the network R has a nominal frequency corresponding to the optimal frequency of the electric current made available by it. This frequency is identical throughout the network. This nominal frequency is for example 50 Hz in Europe and 60 Hz in the United States. The difference between the current frequency and this nominal frequency is representative of an imbalance between the request made to the network and the supply of the network. In particular, a frequency lower than the nominal frequency, for example 46, 47, 48 or 49 Hz in Europe, is indicative of the fact that the request made to the network R is greater than the offer of the network R. Conversely, a frequency higher than the nominal frequency, for example, 51, 52 or 53 Hz in Europe, is representative of a supply greater than the request made to the network.

Note that the difference between the value of the current frequency and the nominal frequency quantifies the imbalance between the supply and demand relative to the network. As such, for example, a difference of 2 Hz on an ilien network may represent an imbalance greater than 10 MW, even 15 MW. An excessively large difference between the current frequency and the nominal frequency can also cause the collapse of the network.

The detection module DETEC is also configured to count the electrical power drawn by the device EQi for its operation over time. For example, it is configured to measure the electrical power drawn by the device EQi for each time step of predetermined duration.

The detection module DETEC is coupled to the planning module to supply data to the latter, including power consumption of device EQi.

The planning module PLAN is configured to plan the operation of said cyclic electrical device defining for said cyclic electrical device at least one cycle phase altered relative to the corresponding nominal phase. Furthermore, it is configured to trigger and/or implement this planning.

“Planning” is understood herein as a scheme of operation of the device EQi which makes the device diverge from its nominal operation.

This planning is based on an estimate of the value of the characteristic quantity GCi of the cyclic electrical device relative to its set value determined by the planning module. As described in more detail below, this estimate is made on the basis of a state variable representative of the progress of the current cycle phase and which constitutes an estimate of the relative value of the characteristic quantity with respect to the corresponding set value.

The planning is associated with a start time corresponding to the planned start time for the implementation of the planning.

With regard to the content of the planning, several modalities are possible.

Advantageously, generally, it includes triggering (that is, causing) the switchover from the current nominal phase of the operating cycle to the next, or to a phase similar to this next phase, that is to say, corresponding to the same type of behavior vis-à-vis the characteristic quantity among a freewheeling phase of the characteristic quantity and an active regulation phase of the characteristic quantity.

Note in particular that a phase similar to a second phase may differ from a second cycle phase as such in that the device does not draw electrical power for the operation thereof. Furthermore, the active control phase may correspond to a first phase of the nominal cycle.

Due to the planning, at least the nominal phase during which the implementation of the planning takes place is impaired, especially in terms of duration.

When the current phase is a first phase, planning results in an erasure of the device. Note that in the second phase thus triggered, the power supply of the device EQi with electrical power is advantageously completely cut off.

“Erasure” is understood herein as a temporary regulation of the power supply of the device EQi considered to reduce its consumption, this regulation advantageously corresponding here to an interruption of the power supply of the device with electrical power.

When the current phase is a second phase, the planning results in an anticipated start up of the active regulation of the characteristic quantity GCi.

More specifically, in the context of the invention, the planning module is configured to build and implement the planning based on the value of a connection function denoted L(t). This function is advantageously defined by the relation:

L(t)=ƒ(ƒᵢ(t),ƒ_{grid}(t))

or ƒ_{grid}(t) is the frequency of the network R and ƒᵢ(t) is a function representative of a threshold value of frequency from which the modification of the operation of the device EQi is considered to be implemented.

This function ƒᵢ(t) depends on the current phase and a state variable denoted E_{ON}(t) for a first phase and E_{OFF}(t) for a second phase.

The state variables are representative of the progress state of the corresponding phase as estimated by the planning module, for example expressed in percent. They are representative of an estimate of the value of the characteristic quantity with respect to the corresponding set value.

The state variable is advantageously estimated at least from the end of the previous phase, the time of which is determined by the detection module DETEC via the measurement of the electrical power drawn by the device, as well as T_{ON} for the first phase and T_{OFF} for the second phase. In practice, the beginning of a first phase is detectable by a sudden substantial increase in the consumption of the device. Furthermore, a sharp drop in consumption indicates the beginning of a second phase.

Regarding T_{ON} and T_{OFF}, these are determined by learning the operation of the device operated by the learning module, as described below.

The dependence of the state variable with respect to time is based on modeling the variation of the characteristic quantity with respect to the corresponding set value during the considered phase.

Due to the fact that it is a modeling, its definition may take into account considerations other than the accuracy of its representation of the variation of the characteristic quantity. In particular, the slightness of the data processing is advantageously also taken into account.

With reference to FIGS. 4A and 4B, for a cycle Ci(j), the variable E_{ON}(t) is advantageously increasing. Advantageously, it varies by a minimum value, for example 0%, at the moment t_{ON,j} at a maximum value, for example 100%, at the moment T_{OFF j} (which is equal to or substantially equal to t_{ON,j}+T_{ON}, for example on average). The variation between these values is, for example, linear. This configuration is particularly advantageous in terms of the computing power required. Nevertheless, other configurations of variation of this variable with respect to t are possible. As such, alternatively, the variation of the state variable is of an exponential configuration, the values taken at the initial and final times remaining, for example, the same.

The variable E_{OFF}(t) is advantageously increasing. It varies by a minimum value, for example 0%, at the time t_{OFF,j} at a maximum value, for example 100%, at the time T_{ON,j} (which is equal to or substantially equal to t_{OFF,j} T_{+OFF}, for example on average). The variation between these values is, for example, linear. Nevertheless, other configurations of variation of this variable with respect to t are possible. As such, alternatively, the variation of the state variable is of an exponential configuration, the values taken at the initial and final times remaining, for example, the same.

Function ƒᵢ(t) has two configurations respectively associated with Tune and the other nominal phases.

In other words, its variation vis-à-vis E_{ON} is different from its variation with respect to E_{OFF}.

For the first phase, the function ƒᵢ has a minimal value ƒ_{i,min1} and a maximum value ƒᵢₘₐₓ₁ that are different from each other. They are preferably strictly lower than the nominal frequency of the network.

These minimum and maximum values are, for example, predefined. They are for example predefined according to the network R, a given network being capable of having a frequency having a degree of variation very different from that of another network. For example, these values are respectively 46 Hz and 49 Hz for a nominal frequency of 50 Hz. In other configurations, these values are closer to the nominal frequency, and differ from the nominal frequency by one tenth of a hertz rather than a hertz.

Function ƒᵢ is for example increasing for the first phase. For example, ƒᵢ(t) is worth the minimum value ƒ_{i,min1} for the minimum value of E_{ON}(t), and the maximum value ƒ_{i,max1} for the maximum value of E_{ON}(T).

Advantageously, ƒᵢ(t) has the minimum value for E_{ON} (t) ranging from its minimum value (for example 0%) to a predetermined value greater than this minimum value. This predetermined value is for example to the order of 20% as in FIG. 5A.

On the remaining portion, ƒᵢ(t) for example varies linearly between this predetermined value of E_{ON}(t) and the maximum value of E_{ON} (for example 100%).

It must be noted that alternatively, the minimum value of ƒᵢ is only taken for a single value of E_{ON}(T).

It must be noted that the linear configuration of ƒᵢ is optional, this function can take another configuration, such as exponential.

Function ƒᵢ(t) has, for the second phase, a minimum value ƒ_{i,min2} and a maximum value ƒ_{i,max2} that are different from each other. These minimum and maximum values are preferably strictly greater than the nominal frequency. They are for example predefined according to the network. For example, they correspond respectively to 51 Hz and 55 Hz for a nominal frequency of 50 Hz. Like before, they are, however, alternately closer to this nominal frequency, and deviate from it by a quantity to the order of a tenth of a hertz.

Function ƒᵢ(t) is advantageously decreasing for the second phase. The maximum value ƒ_{i,max2} is for example taken for minimal E_{OFF}(t). Furthermore, the minimum value ƒ_{i,min2} is advantageously taken for maximum E_{OFF}(t).

Advantageously, ƒᵢ(t) has (for the second phase) the maximum value for E_{OFF}(t) ranging from its minimum value (for example 0%) to a predetermined value greater than this minimum value (for example 20% as in FIG. 5B). This predetermined value is a priori decorrelated from the predetermined value of E_{ON}(t) up to which f is the minimum value in the first phase.

On the remaining portion, ƒᵢ(t) for example varies linearly between this predetermined value of E_{OFF}(t) and the maximum value (for example 100%).

With regard to f, it is advantageously configured to take one of two values, high for one and low for the other. These values are for example 1 and 0.

One of the values, for example the high value, is taken when a given condition relating to a quantity representative of the difference between ƒᵢ(t) and ƒ_{grid}(t) is verified, and the other value is taken if this condition is not verified.

This condition is advantageously defined from the difference between the values ƒᵢ(t) and ƒ_{grid}(t) at the time considered, and advantageously corresponds to the comparison between this difference itself and 0.

Note that the condition itself or the criterion determining whether this condition is considered as verified may differ depending on the current phase.

For example, in the example of the Figures, if f is constructed to take the high value if the difference between ƒᵢ(t) and ƒ_{grid}(t) is negative whatever the current phase and inversely its low value, so, at nominal frequency of the network, L will take the high value in the first phase and its low value in the second phase without this being detected as meaning that planning is required.

In addition, the construction of f can be adjusted according to the current phase so that a given value is associated with a lack of planning, and the other value is the inverse trigger of a planning.

As a function of at least the value of L and the nature of the current phase, the planning module detects that a planning is to be implemented at a given time and determines the nature of this planning (which in practice is an erasure in the case of a first phase in progress, and an anticipated start in the case of a current second phase).

Note that this detection that a planning is to be implement optionally includes an additional condition relating to maintaining L over time at a given value, for example over a predetermined period of time of a chosen duration.

The given time is for example the time corresponding to the detection time of the change in the value of L indicative of the fact that a planning is required. Alternatively, this time is moved in time, for example of a predetermined duration.

In response, the module MODi, and in particular the planning module, is configured to trigger the implementation of the planning defined at the associated time.

Here again, the modalities of this trigger vary according to the nature of the intended planning.

For a planning corresponding to an erasure, the module MODi is configured to control the disconnection of the device EQi from the network via the disconnection module DIS.

For a planning corresponding to an anticipated start, the module MODi is advantageously configured to send to the device EQi a corresponding signal whose reception by the device EQi results in the start of the active regulation of the characteristic quantity via a consumption of electrical power.

In addition, advantageously in this configuration, the module MODi is integrated with the device EQi and is adapted to communicate with a control device for controlling the components configured to regulate the characteristic quantity (for example in particular of the compressor COMP in the case of a cold generator device). Nevertheless, a module MODi according to the first configuration is also possible, in which case it is further configured to send signals of this type to this control device (for example via wired communication means or not).

In addition to the features described above, several ways of switching over the device EQi to its nominal operation from the planning are intended. All or part of these modalities can be implemented by the module MODi, which is then configured for this purpose.

In a given embodiment, this switchover is triggered in response to the change of the value of L(t) from its current value to its other value in a two-value configuration. For example, if the planning is configured to be triggered in response to the fact that L(t) is the high value thereof, and the planning corresponds to an erasure, the erasure then ends when L(t) returns to its low value, this is for example the case if the frequency of the network returns to the nominal value.

This return to nominal operation is optionally triggered by the module MODi, which sends a signal to this effect to the device and/or connects or disconnects the device to the network via the module DIS.

In another embodiment, this switchover is triggered after a predetermined period of time. For an erasure, this period of time is for example determined according to the value of T_{OFF} and the state variable E_{OFF}(t) at the time of implementation of the planning. Alternatively, this period of time is determined randomly, for example under the constraint of intervening during a given time interval.

Like before, this triggering of the nominal operation is advantageously implemented by the module MODi, for example according to the same modalities as above.

In another embodiment, this switchover is performed in response to the characteristic quantity crossing or reaching a threshold value (which may correspond to a set value implemented during a nominal phase).

We notice that advantageously, this modality is implemented by the device itself, which spontaneously returns to its nominal operation. Optionally, this return is authorized by the module MODi, notably via the reconnection of the device to the network R by the disconnection module DIS.

Alternatively or in parallel, this switchover is made in response to the state variable associated with the nominal phase or the analogous phase defined by the planning crossing or reaching a threshold value. Advantageously, during a planning phase that defines a similar phase (typically a second nominal phase), the module MODi tracks the state variable E_{OFF}(t) as if a second phase were in progress taking into account the value of the state variable E_{ON}(t) during the first phase during which erasure occurred. A similar tracking of the variable E_{ON}(t) is performed in an anticipated start taking into account the value of E_{OFF}(t) at the time of the anticipated start.

Like before, this mode of return to the nominal operation is advantageously implemented by the module MODi.

Advantageously, many or all of these conditions are used in combination, and each form one of the conditions jointly employed. The switchover is for example performed upon verification of any number of these conditions, between one and the number of conditions used. For example, this switchover takes place in response when a number is verified. Optionally, one or more are defined as critical and must then be checked for the switchover to be made.

Note that the detail of the return of the device EQi to nominal operation depends on the planning implemented.

For an erasure (that is, if an erasure is in progress), the module MODi is configured to reconnect the device to the network via the disconnection module, which is controlled for the closure of the conductors.

The device then returns in a first phase in response to the corresponding instruction being achieved by the characteristic quantity.

Alternatively, the module MODi forces the start of a first phase by sending a command adapted for this purpose to the device EQi, or to the control device of the chain of devices responsible for the regulation of the characteristic quantity.

We note that optionally, the module MODi is adapted to control the electrical connection of the device EQi to a backup electric power storage device coupled to the device EQi and to the module MODi, for example via the control of the disconnection module DIS which is then adapted to perform this selective connection/disconnection. This connection is made together with that of the device to the network, or instead of the same.

For an anticipated start (that is, if a control phase of the characteristic quantity is in progress due to an anticipated start), the device returns to the second phase once the characteristic quantity has reached the set value of the corresponding phase.

Alternatively, the module MODi causes the active regulation of the characteristic quantity to be terminated by disconnecting the device from the network via the disconnection module DIS. We notice that advantageously, the module prohibits this termination of the regulation for a predetermined period of time after starting the compressor COMP. Advantageously, this period of time has a duration corresponding to the duration over which the function ƒ; has a zero value for the first phase (which corresponds for example to 20% of the value of T_{ON}).

Still with reference to FIG. 3, the training module LEARN is configured to generate training data based on the nominal operation of the EQi device.

These learning data includes the quantities T_{ON} and T_{OFF}.

Advantageously, these data also include a characterization of the variation of the characteristic quantity during the two phases of the nominal cycle.

For the construction of these data, during the cycles, the module LEARN detects the attainment of GCimin when the device EQi passes from its first phase to its second phase and the power demand of the device EQi on the network is decreased by a value corresponding to all or part of the consumption of device EQi. In a similar way, the attainment of GCimax is detected when the consumption of the device EQi increases by a value corresponding to all or part of the consumption of the device EQi.

The dates on which GCimin (j) and GCimax (j) are reached respectively define the end of the first phase and the second phase of the operating cycle Ci(j) of the device EQi.

The duration of the current phase, T_{ON}(j) OR T_{OFF}(J), is determined by the module LEARN from previous nominal cycles (which may have been the site of a disturbance). The duration of training makes it possible to increase the statistical knowledge of the nominal cycles for a given device EQi and makes it possible to improve the inclusion of the disrupted cycles (for example following a door opening for a refrigerator and/or freezer).

It must be noted that the values T_{ON} and T_{OFF} may vary over time. More specifically, they are advantageously constructed to depend on the time of day considered, the day of the week in question, of the month in question and/or the season in question. Especially, these quantities are likely to vary because of the temperature outside the device EQi, which is influenced by the time of day and the season in question, because of user actions, which tend to be more frequent during the day than at night and on non-working days, etc.

Concerning the characterization of the variation of the characteristic quantity, this is for example carried out on the basis of an initial characterization of the characteristic quantity, taking into account the nature of the device. For example, this initial characterization defines a variation profile of the quantity GCi of exponential type for each phase. This characterization is then adjusted, namely in terms of parameterization, to take into account the quantities determined, such as T_{ON} and T_{OFF}, for example so that the extrema of this characterization coincide temporally with the phase beginnings and ends.

Optionally, the characterization of the variation of the characteristic quantity is used to adjust the configuration of the variation of the state variables as a function of time. In the absence of such adjustment, for example, the state variables have a predetermined selected configuration.

A method for managing the group P will now be described with reference to the Figures, particularly to FIG. 6, especially from the perspective of a given device EQi and associated module MODi.

During a learning step S1, the module MODi, in particular the detection module DETEC and the learning module LEARN, collects data on the nominal operation of the device EQi, and in particular so that the learning module LEARN determines the values of the quantities T_{ON} and T_{OFF} and, advantageously the characterization of the variation of the characteristic quantity GCi during the phases of the nominal cycle, advantageously used for the construction of the variations of the state variables E_{ON} and E_{OFF}.

During a step S2, the detection module DETEC tracks the frequency of the network, and provides this information to the planning module PLAN. It tracks the value of the function L(t) over time, as described above. The values followed are for example determined at a regular frequency. Furthermore, advantageously this tracking continues throughout the operation of the device EQi after the step S1 is completed.

During a step S3, the function L(t) takes a value triggering the construction and implementation of a planning of the operation of the device EQi at the associated start time.

For example, as previously described, this planning is an erasure, the device previously being in the first phase. Alternatively, this planning is an anticipated start of a first phase, the device previously being in the second phase. During a step S4, the device EQi returns to its nominal operating mode, optionally by triggering or allowing this return by the module MODi. This is done in response to the verification of the associated conditions described above.

Steps S3 and S4 are for example repeated over time, the steps S3 occurring in response to changes in the value of the function L over time which are representative of the conditions for triggering an adjustment of the operation of the device EQi.

These steps are also repeated for all devices EQi equipped with a module MODi.

The invention has several advantages.

First of all, it makes it possible to distribute the disconnections of the devices of the group in an equitable way and without damaging their operation insofar as it proceeds on the basis of an evaluation of their current state, aiming to determine if this state is compatible with a planning, allowing better control of the consumption of these devices in view of the state of the network.

Especially, the configuration of the L function makes it possible to favor the application of a planning operation, namely an erasure, to devices that does not substantially disturb, and conversely limit the application of these plannings to devices in such a state that a planning could affect their operation (for example by promoting the wear of the component thereof and thereby degrading their lifespan).

Furthermore, the invention proceeds without an exchange of state data between the device and the module MODi, which makes its implementation easier and more immediate.

Moreover, the possible plans are varied, so that the invention is a powerful tool for adjusting the consumption of a group of electrical devices to the situation of the electrical network supplying them.

Some variants are possible.

In particular, it is noted that the function ƒ associated with the function L can also depend on the reception of an external control signal supplied to the module MODi, for example by a remote device. This signal is for example provided by PLC technology. The function ƒ is for example constructed to take a given value in response to the reception of this command, this value triggering planning and its implementation. The return to the nominal operation is for example triggered by an external end of planning signal, or on the basis of one, several or all of the conditions described above. Note that this signal can be decorrelated from the value of the frequency of the network.

Furthermore, advantageously at least one module MODi is coupled to a backup electrical power storage device that is adapted to electrically connect to the device EQi, for example via the disconnection module DIS. This auxiliary device is advantageously used as a source of electrical power for the operation of the device EQi in the location of the network (or jointly with it), in order to limit the energy drawn from the network. This is for example implemented in the case where the frequency of the network is lower than the nominal frequency, but a control phase of the characteristic quantity must nevertheless be implemented by the device (for example following an erasure). The module MODi then commands the disconnection module DIS to connect the device EQi to the backup storage device.

It is further noted that advantageously, the module MODi comprises a human-machine interface, allowing the user to enter at least one command taken into account in the operation of the module MODi. For example, the human-machine interface is adapted to allow the user to signal to the module MODi that the implementation of plannings is not allowed. This input is for example made via one or more buttons, optionally combined with a display in the form of a tactile graphical interface.

Moreover, any indicator other than the network frequency and indicative of an imbalance between supply and demand on the network R may be used, possibly together with this frequency, such as for example one or more voltages provided by the network, or a gradient of the frequency and/or a gradient of this or these voltages. However, the frequency of the network is particularly advantageous.

Advantageously, moreover, the method comprises a step of the module MODi communicating with a remote device, such as a remote platform. This communication is for example provided for the initial activation of the module MODi, for example via a key exchange.

Furthermore, advantageously the method comprises the exchange of information between the module MODi and another device, for example remote or temporarily coupled to the module MODi.

Such an exchange is for example provided for updating the frequency values of the network used, and/or for the transmission of information to a network operator, such as diagnostic or performance information.

Alternatively or in parallel, this exchange is intended for the module MODi to declare itself active with a remote platform.

In this last case, for example, the exchange of information is unidirectional, the information being sent by the module MODi to this center.

Advantageously, this is a one-time exchange. For example, it is performed at a regular frequency.

Moreover, we note that a device EQi can be associated with several characteristic quantities GCi. Advantageously, the device then comprises respective device chains associated with the regulation of one of the quantities GCi, for example two separate cooling circuits, these chains being independent of one another. In other words, a device can be adapted to present a cut-off operation in independent cyclic sub-operations in terms of electrical power consumption, each sub-operation aimed at regulating one of the characteristic quantities GCi. Advantageously, the device is associated with a module MODi, or a module MODi for each characteristic quantity that it is configured to be regulated. Advantageously, this or these modules are then integrated into the device, and are designed to operate as described above, preferably via an interaction with the control devices of these device chains, for the implementation of the invention in a parallel manner on each of the characteristic quantities.

The quantity representative of an estimate of the value of the characteristic quantity of the cyclic electrical device relative to the set value of the current phase can correspond to a state progress variable during a phase of a cycle. For example, said representative quantity may take the form of a percentage applied to a characteristic quantity. In the example of a refrigerator for which the characteristic quantity is a temperature, the temperature usually goes up or down, during a phase of a cycle, from an initial temperature Tᵢₙᵢₜ up to a set temperature T_{cons}. The operational planning can include, for example, at least one altered cycle when said quantity is between X % and Y %, where the values of X and Y are for example dependent on the nature of the current cycle (active cooling or standby) and under the condition that a balance (or on the contrary an imbalance) is detected on the network.

For example, for a current phase corresponding to the nominal phase of active regulation of the temperature, the altered cycle can correspond to the transition from the nominal phase of active regulation of the temperature to the passive nominal phase (absence of regulation of the temperature) when the evolution of the temperature reaches at least 80% of the cooling of Tᵢₙᵢₜ up to T_{cons} and that an imbalance on the network is found. As such, the power consumption is stopped in advance, which contributes to reducing the imbalance on the network while having a limited impact for the user: a cooling of 80% of the usual cooling is sufficient to ensure a desired temperature for a time due to the thermal inertia. For a current phase corresponding to the passive nominal phase (no temperature regulation), the altered cycle may correspond to the early triggering of the active regulation phase when the change in temperature reaches at least 50% of the warming of Tᵢₙᵢₜ up to T_{cons} and no imbalance on the network is found. In other words, rather than waiting for the temperature to heat up naturally until the nominal trigger threshold of the active phase, the active phase is triggered early. As such, the power consumption is advanced in time, which contributes to reducing the risk of a subsequent imbalance on the network. In such an example, the durations of each of the cycles can be reduced compared to their nominal duration in order to shift in time the phases during which the device consumes energy on the network. In other words, the time elapsing between the times T_{ON} and T_{OFF} (and between T_{OFF} and T_{ON}) are reduced for the device in relation to known nominal durations. When such a method is applied to a plurality of devices powered by a common network, even when the processes are not coordinated with one another (lack of centralization), this tends to reduce the quantity of the load peaks on the network by shifting the consumption over time (before and after peak loads). Note that it is not imperative to monitor directly and continuously the temperature (by sensors) but that an estimate of the evolution between Tᵢₙᵢₜ and T_{cons}, for example on the basis of prior observations, may be sufficient.

1. A method for managing a group of electrical devices (EQi) connected to an electrical power supply network (R), the group comprising at least one so-called cyclic electrical device initially employing a nominal cyclic operation comprising a plurality of nominal cycles (Ci (j)), each nominal cycle comprising a first nominal phase (P1) during which the cyclic electrical device draws electrical power from the network in order to regulate a characteristic quantity (GCi) of said device as a function of a first set value, and a second nominal freewheel phase during which the device does not use electrical power to regulate said characteristic quantity, said characteristic quantity tending towards a second nominal set value in second nominal phase, the method comprising:
for at least one cyclic electrical device, planning the operation for said cyclic electrical device, defining, for said cyclic electrical device, at least one cycle phase that is altered relative to the corresponding nominal phase, said planning being based on at least:
the nature of a current phase among the first and second nominal phases,
a quantity adapted to be representative of an imbalance between a request for electrical power made to the supply network and the electrical power made available by the supply network, and
a quantity representative of an estimate of the value of the characteristic quantity of said cyclic electrical device relative to the set value of the current phase, the planning;
and implementing said planning from the start time.

2. The method according to claim 1, further comprising a learning step (S1) during which operating data of said cyclic electrical device is collected, said quantity representative of an estimate of the value of the characteristic quantity of said cyclic electrical device relative to a set value of the current phase being based at least depending on the operating data collected during the learning step.

3. The method according to claim 1, wherein the intended time is chosen to intervene during a given phase of the nominal cycle and before the intended end of said given phase, said given phase forming an altered cycle phase.

4. The method according to claim 3, wherein said given phase is a first phase, the planning defining an erasure of said cyclic electrical device.

5. The method according to claim 1, wherein the planning module is configured to build and implement the planning based on the value of a connection function denoted L(t). defined by the ratio:
L(t)=ƒ(ƒᵢ(t),ƒ_{grid}(t))
or ƒ_{grid}(t) is a frequency of an electric current supplied by the network R and ƒᵢ(t) is a function of a variable value over time and representative of a threshold value of the frequency of the network according to which the implementation of a planning of the operation of the device (EQi) is detected as to be implemented.

6. The method according to claim 5, wherein the function ƒᵢ(t) depends on the current nominal phase at time t and a state variable (E_{ON}(t), E_{OFF}(t)) representative of the estimated progress of the corresponding nominal phase and constituting an estimate of the value of the characteristic quantity relative to the corresponding set value.

7. The method according to claim 6, wherein, in the nominal first phase, function ƒᵢ(t) is increasing between a minimum value and a maximum value strictly lower than a nominal value of the frequency of the current supplied by the network R.

8. The method according to claim 7, wherein the function ƒᵢ(t) is the minimum value over a range of values of the corresponding state variable from a minimum value of said state variable corresponding to a value of the variable state strictly greater than said minimum value.

9. The method according to claim 6, wherein, in the second nominal phase, function ƒᵢ(t) is decreasing between a maximum value and a minimum value strictly greater than a nominal value of the frequency of the current supplied by the network.

10. A computer program comprising instructions for implementing the method according to claim 1 when executed by a processor.

11. A group of electrical devices connected to an electrical power supply network (R), the group (P) comprising at least one so-called cyclic electrical device adapted to initially employ a nominal cyclic operation comprising a plurality of nominal cycles, each nominal cycle comprising a first nominal phase (PI) during which the device draws electrical power from the network in order to regulate a characteristic quantity (GCi) of said device as a function of a first set value, and a second nominal freewheeling phase during which the device does not use electrical power to regulate said characteristic quantity, said characteristic quantity tending towards a second nominal set value in second phase, the group of devices comprising at least one management module (MODi) associated with said cyclic electrical device and comprising:
a detection module (DETEC) configured to determine a quantity adapted to be indicative of an imbalance between a request for electrical power made to the supply network and the electrical power made available by the supply network,
a planning module (PLAN) coupled to said detection module (DETEC) and configured to plan the operation of said cyclic electrical device defining for said cyclic electrical device at least one cycle phase altered relative to the corresponding nominal phase, said planning being based on at least:
the nature of a current phase among the first and second nominal phases,
the quantity adapted to be indicative of an imbalance between a request for electrical power made to the supply network and the electrical power made available by the supply network, and
a quantity representative of an estimate of the value of the characteristic quantity of:
said cyclic electrical device relative to the set value of the current phase,
the planning being associated with an initial time intended for the implementation of said planning, the planning module being further configured to trigger the implementation of said planning by the cyclic electrical device from the initial time.

12. A group according to claim 11, wherein the management module (MODi) is external to said cyclic electrical device and is arranged to connect the cyclic electrical device to the supply network for supplying said cyclic electrical device with electrical power.

13. The group according to claim 11, wherein the management module (MODi) is integrated with said cyclic electrical device.
